(19) United States
(12) Patent Application Publication
(10) Pub. No.: US 2009/0089377 A1
(43) Pub. Date: Apr. 2, 2009

(54) SYSTEM AND METHOD FOR PROVIDING DYNAMIC EMAIL CONTENT

(75) Inventor: Benjamin I. Rubinger, Somerville, MA (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/862,519

(22) Filed: Sep. 27, 2007

(51) Int. Cl. G06F 15/16

(52) U.S. Cl. 709/206

(57) ABSTRACT

A method and computer program product for providing dynamic email content includes sending a request for dynamic email content. The dynamic email content is received from a data store. At least a portion of an email message is populated with the received dynamic email content.

### TECHNICAL FIELD

This disclosure relates to email systems, more particularly, relates to email systems allowing the inclusion of dynamic email content.

### BACKGROUND

Often it may be desirable to append content, such as a footer to an email message. In the context of a customer support reply email, it may be desirable to include, for example, information that is specific to a product, such as information about updates, new versions, tips, and the like. In conventional email systems, such information may be stored as signatures, which may be easily applied to the email before it is sent out to the customer. While including such information in the email may be relatively easy, it requires that the user of the email system select an appropriate piece of information and include the information with the email. Additionally, it must be ensured that all customer service representatives are using consistent information, e.g., in terms of formatting, language usage, and the like.

Additionally, the very nature of information that may desirably be included with customer support reply emails is such that it changes over time, perhaps even frequently. For example, information about updates, seminars, and the like is perishable, in that it may quickly become irrelevant due to a new update, the passing of a seminar date, and so on. As a result, the information must be frequently updated. Using conventional signature functionality to append the information to an email would require that the text within the various signature stores of each individual email client must be updated whenever a change in the information is desired. In large organizations, updating the signature stores of every email client of customer service team may be an extremely cumbersome and time consuming task.

### SUMMARY OF THE DISCLOSURE

According to one implementation, a method includes sending a request for a dynamic email content. The dynamic email content is received from a data store. At least a portion of an email message is populated with the received dynamic email content.

One or more of the following features may be included. Sending the request for dynamic email content may include sending a request for the dynamic email content based upon, at least in part, one or more attributes of the email message. The one or more attributes of the email message may include one or more of a subject matter of the email message; a language of the email message; and a geographic location of one or more intended recipients of the email message. Further, sending the request for dynamic email content may include sending a web service request to the data store.

Receiving the dynamic email content may include receiving a web service response from the data store including the dynamic email content. Further, receiving the dynamic email content may include receiving dynamic email content selected based upon, at least in part, one or more attributes of the email message. The one or more attributes of the email message may include one or more of a subject matter of the email message, a language of the email message, and a geographic location of one or more intended recipients of the email message. The data store may include a centrally managed database accessible by a plurality of email clients.

Populating at least a portion of the email message may include providing at least one email footer including the received dynamic email content. Additionally, the method may further include receiving by an email client an indicator of one or more of a subject matter of the email message, a language of the email message, and a geographic location of at least one intended recipient of the email message.

According to another implementation, a computer program product resides on a computer readable storage medium having a plurality of instructions stored on it. When executed by a processor, the instructions cause the processor to perform operations including sending a request for a dynamic email content. The dynamic email content is received from a data store. At least a portion of an email message is populated with the received dynamic email content.

One or more of the following features may be included. The instructions for sending the request for dynamic email content may include instructions for sending a request for the dynamic email content based upon, at least in part, one or more attributes of the email message. the one or more attributes of the email message may include one or more of a subject matter of the email message; a language of the email message; and a geographic location of one or more intended recipients of the email message. Additionally, the instructions for sending the request for dynamic email content may include instructions for sending a web service request to the data store.

The instructions for receiving the dynamic email content may include instructions for receiving a web service response from the data store including the dynamic email content. Further, the instructions for receiving the dynamic email content may include instructions for receiving dynamic email content selected based upon, at least in part, one or more attributes of the email message. The one or more attributes of the email message include one or more of a subject matter of the email message, a language of the email message, and a geographic location of one or more intended recipients of the email message. The data store may include a centrally managed database accessible by a plurality of email clients.

The instructions for populating at least a portion of the email message may include instructions for providing at least one email footer including the received dynamic email content. The computer program product may further include instructions for receiving by an email client an indicator of one or more of a subject matter of the email message, a language of the email message, and a geographic location of at least one intended recipient of the email message.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a dynamic content process coupled to distributed computing network.

FIG. 2 is a flowchart of a process that may be executed by the dynamic content process of FIG. 1.

FIG. 3 diagrammatically shows an email creation interface that may be rendered by the dynamic content process and/or a client email application of FIG. 1.

FIG. 4 diagrammatically depicts a display screen that may be rendered by a customer service problem management software of FIG. 1.

FIG. 5 diagrammatically depicts a data structure within a database of FIG. 1.

FIG. 6 diagrammatically depicts an email creation interface that may be rendered by the dynamic content process and/or a client email application of FIG. 1.

### DETAILED DESCRIPTION

### System Overview:

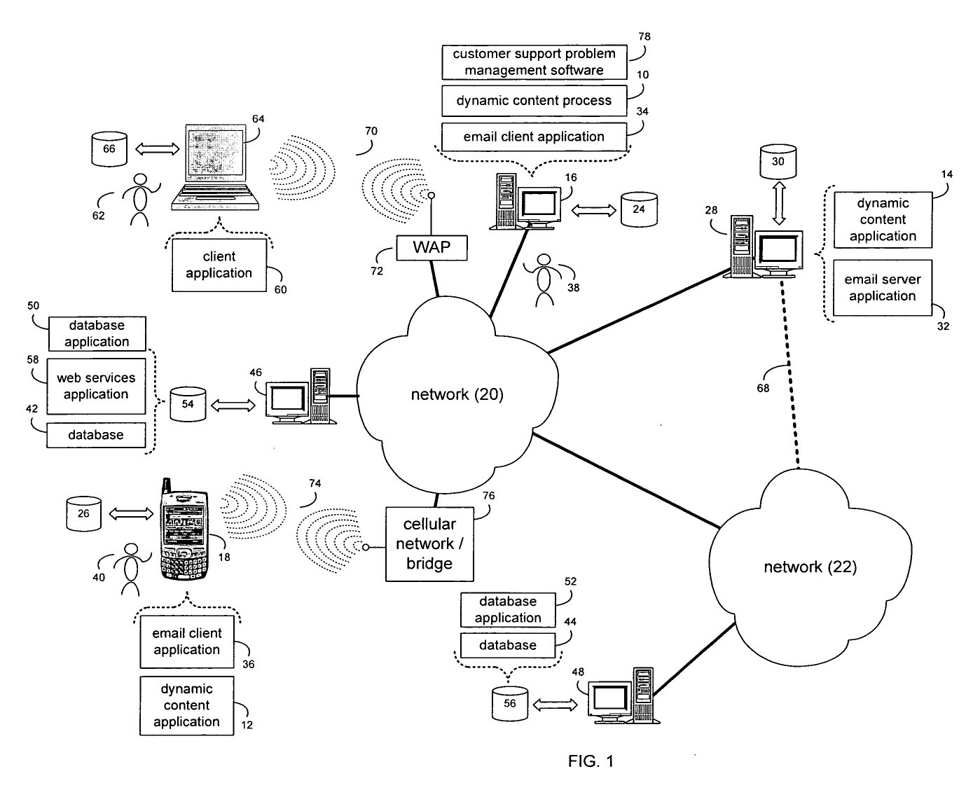

Referring to FIG. 1, there is shown a dynamic content process. As will be discussed below, the dynamic content process may send a request for dynamic email content. The requested dynamic email content may be received from a data store. Further, at least a portion of an email message may be populated with the received dynamic email content.

The dynamic content process may be a client-side process (e.g., dynamic content process 10, 12) a server-side process (e.g., dynamic content process 14), or a hybrid client-side/server-side process (e.g., the combination of one or more of client-side dynamic content process 10, 12 and server-side dynamic content processes 14).

Client-side dynamic content processes 10, 12 may reside on and may be executed by one or more client electronic device (e.g., client electronic devices 16, 18; respectively), examples of which may include but are not limited to personal computer 16, personal digital assistant 18, a laptop computer (not shown), a notebook computer (not shown), a data-enabled, cellular telephone (not shown), and a dedicated network device (not shown), for example. Client electronic devices 16, 18 may each be coupled to network 20 and/or network 22 and may each execute an operating system, examples of which may include but are not limited to Microsoft Windows™, Microsoft Windows CE™, Redhat Linux™, or a custom operating system.

The instruction sets and subroutines of client-side dynamic content processes 10, 12, which may be stored on storage devices 24, 26 (respectively) coupled to client electronic devices 16, 18 (respectively), may be executed by one or more processors (not shown) and one or more memory architectures (not shown) incorporated into client electronic devices 16, 18 (respectively). Storage devices 24, 26 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Server-side dynamic content process 14 may reside on and may be executed by server computer 28, which may be connected to network 20 (e.g., the Internet or a local area network). Examples of server computer 28 may include, but are not limited to: a personal computer, a server computer, a series of server computers, a mini computer, and a mainframe computer. Server computer 28 may be a web server (or a series of servers) running a network operating system, examples of which may include but are not limited to: Microsoft Windows XP Server™; Novell Netware™; or Redhat Linux™, for example.

The instruction sets and subroutines of server-side dynamic content process 14, which may be stored on storage device 30 coupled to server computer 28, may be executed by one or more processors (not shown) and one or more memory architectures (not shown) incorporated into server computer 28. Storage device 30 may include but is not limited to: a hard disk drive; a tape drive; an optical drive; a RAID array; a random access memory (RAM); and a read-only memory (ROM).

Server computer 28 may execute a web server application, examples of which may include but are not limited to: Microsoft IIS™, Novell Webserver™, or Apache Webserver™, that allows for HTTP (i.e., HyperText Transfer Protocol) access to server computer 28 via network 20. Network 20 may be connected to one or more secondary networks (e.g., network 22), examples of which may include but are not limited to: a local area network; a wide area network; or an intranet, for example.

Additionally, server computer 28 may execute an email server application (e.g., email server application 32). Examples of email server application 32 may include but are not limited to Lotus Domino™ Server and Microsoft Exchange™ Server. Email server application 32 may be a mail transfer agent that may store and route email to/from one or more email client application (e.g., email client application 34, 36), examples of which may include but are not limited to Lotus Notes™ and Microsoft Outlook™.

The instruction sets and subroutines of email client applications 34, 36, which may be stored on storage devices 24, 26 (respectively) coupled to client electronic devices 16, 18 (respectively), may be executed by one or more processors (not shown) and one or more memory architectures (not shown) incorporated into client electronic devices 16, 18 (respectively). As mentioned, storage devices 24, 26 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Using email client applications 34, 36, users 38, 40 may access email server application 32 and may send, retrieve and/or organize email messages.

Client-side dynamic content process 10, 12 may be a stand alone application that interfaces with email client application 34, 36, or an applet/application that is executed within email client application 34, 36. Similarly, if the dynamic content process is configured as server-side dynamic content process 14, dynamic content process 14 may be a stand along application that interfaces with email server application 32, or an applet/application that is executed within email server application 32.

One or more data stores (e.g., databases 42, 44) may reside on one or more computing devices (e.g., computing devices 46, 48, respectively), examples of which may include but are not limited to: a personal computer, a server computer, a series of server computers, a mini computer, and a mainframe computer, for example. Computing devices 46, 48 may each be coupled to network 20 and/or network 22 and may each execute an operating system, examples of which may include but are not limited to Microsoft Windows™, Redhat Linux™, Microsoft Windows XP Server™; Novell Netware™, or a custom operating system, for example.

Databases 42, 44 may be accessible by one or more database application (e.g., database application 50, 52), examples of which may include, but are not limited to such as an Oracle™ database, and IBM DB2™ database, a Sybase™ database, a Computer Associates™ database, or a Microsoft Access™ database, for example. The instruction sets and subroutines of database application 50, 52, which may be stored on storage devices 54, 56, respectively, coupled to computing devices 46, 48, may be executed by one or more processors (not shown) and one or more memory architectures (not shown) incorporated into computing devices 46, 48. Storage devices 54, 56 may include are is not limited to: a hard disk drive; a tape drive; an optical drive; a RAID array; a random access memory (RAM); and a read-only memory (ROM), for example.

Additionally, one or more web services application (e.g., web services application 58) may reside on and be executed by one or more computing devices (e.g., computing device 46) Web services application 58 may provide web service access to one or more of databases 42, 44. For example, client application 60 (e.g., which may be a web browser) may allow a user (e.g., user 62) to access one or more of databases 42, 44 via web services requests provided by web services application 58. Client application 60 may reside on a client electronic device (e.g., client electronic device 64), examples of which may include, but are not limited to, laptop computer 64, a personal computer (not shown), personal digital assistant (not shown), a notebook computer (not shown), a data-enabled, cellular telephone (not shown), and a dedicated network device (not shown), for example. Client electronic device 64 may be coupled to network 20 and/or network 22 and may execute an operating system, examples of which may include but are not limited to Microsoft Windows™, Microsoft Windows CE™, Redhat Linux™, or a custom operating system.

The instruction sets and subroutines of client application 60, which may be stored on storage device 66 coupled to client electronic device 64, may be executed by one or more processors (not shown) and one or more memory architectures (not shown) incorporated into client electronic device 64. Storage device 66 may include but is not limited to: hard disk drives; tape drives; optical drives; RAID arrays; random access memories (RAM); read-only memories (ROM), compact flash (CF) storage devices, secure digital (SD) storage devices, and a memory stick storage devices.

Users 38, 40 may access client-side dynamic content process 10, 12 directly through the device on which the client-side dynamic content process is executed, namely client electronic devices 16, 18, for example. Users 38, 40 may access server-side dynamic content process 14 directly through network 20 and/or through secondary network 22. Further, server computer 28 (i.e., the computer that executes server-side dynamic content process 14) may be connected to network 20 through secondary network 22, as illustrated with phantom link line 68.

The various client electronic devices 16, 18, 64 and computing devices 46, 48 may be directly or indirectly coupled to network 20 (or network 22). For example, personal computer 16 is shown directly coupled to network 20 via a hardwired network connection. Further, computing device 48 is shown directly coupled to network 22 via a hardwired network connection. Laptop computer 64 is shown wirelessly coupled to network 20 via wireless communication channel 70 established between laptop computer 64 and wireless access point (i.e., WAP) 72, which is shown directly coupled to network 20. WAP 72 may be, for example, an IEEE 802.11a, 802.11b, 802.11g, Wi-Fi, and/or Bluetooth device that is capable of establishing wireless communication channel 70 between laptop computer 64 and WAP 72. Personal digital assistant 18 is shown wirelessly coupled to network 20 via wireless communication channel 74 established between personal digital assistant 18 and cellular network/bridge 76, which is shown directly coupled to network 20.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Various other connection arrangements between the various client electronic devices 16, 18, 64; computing devices 46, 48; server computer 28 and networks 20, 22 may be used, as will be readily understood.

### Dynamic Content Process:

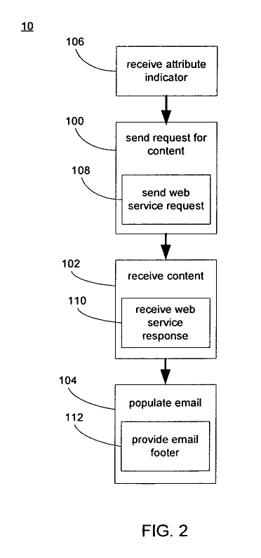

Referring also to FIG. 2, dynamic content process 10, 12, 14 may send 100 a request for a dynamic email content. Dynamic content process 10, 12, 14 may receive 102 dynamic email content from a data store. Additionally, dynamic content process 10, 12, 14 may populate 104 at least a portion of an email message with the received 102 dynamic email content.

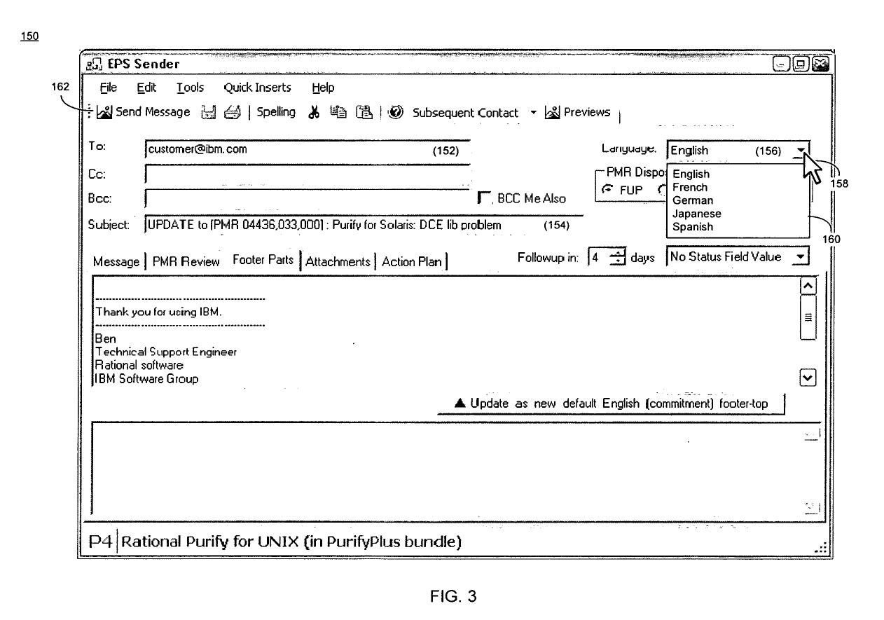

For example, and referring also to FIG. 3, dynamic content process 10 and/or email client application 34 may render email creation interface 150 including, for example, “To” field 152, “Subject” field 154, “Language” field 156, as well as various additional fields and/or features. User 38 may input (e.g., using a keyboard; not shown) an intended recipient of the email being created, namely “customer@ibm.com.” Similarly, user 38 may input (e.g., using a keyboard) a subject of the email. Additionally, user 38 may select a language of the email, e.g., by selecting “Language” field 156 using on-screen pointer 158 controlled by a pointing device (e.g., a mouse; not shown). Selecting “Language” field 156 may result in dynamic content process 10 and/or email client application 34 rendering language dropdown menu 160, including one or more available languages for the email. Using on-screen pointer 158, user 38 may select a language of the email from language dropdown menu 160.

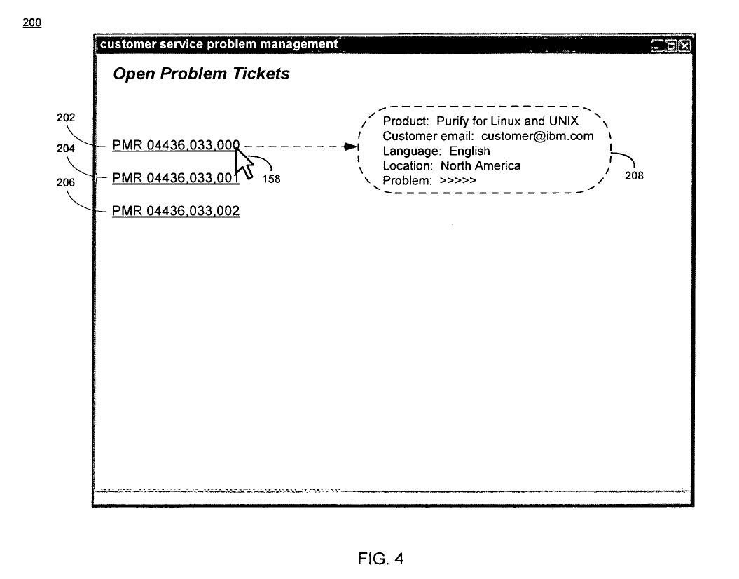

In addition/as an alternative to manually inputting one or more intended email recipient, subject, language, and other fields of the email, one or more of the email fields (e.g., “To” field 152, “Subject” field 154, and “Language” field 156) may be automatically filled. For example, in the context of a customer support implementation, a customer support request may be assigned a “problem ticket” associated with the customer support request. Referring also to FIG. 4, display screen 200 rendered by customer service problem management software 78 (e.g., which may reside on and be executed by client electronic device 16 and/or server computer 28, for example) may include “problem tickets” 202, 204, 206 associated with respective customer support requests. Each “problem ticket” 202, 204, 206 include associated customer information (e.g., customer information 208 associated with “problem ticket” 202), which may include, for example, customer identification and contact information, product information, and the like. For example, “problem ticket” 202 may be associated with a customer having an email address “customer@ibm.com”. “Problem ticket” 202 may relate to an issue with Purify™ for Linux and UNIX. English may be designated as the preferred contact language, and the customer may be located in North America. Various additional/alternative information may also be included.

One or more of dynamic content process 10 and/or email client application 34 may receive 106 one or more email attributes from customer service problem management software 78. The one or more email attribute received 106 may include one or more of a subject matter of the email message, a language of the email message, and a geographic location of at least one intended recipient of the email message. Attributes of the email message may be populated based upon information associated with “problem ticket” 202, e.g., via interaction between email client application 34 and customer service problem management software 78.

Dynamic content process 10 may send 100 the request for dynamic email content, for example, when one or more attributes of the email message are defined (e.g., via user input or via auto-filling by email client application 34 or another application, such as customer service problem management software 78), when email creation interface 150 is opened (e.g., in response to selecting, via onscreen pointer 158, “problem ticket” 202), when the email is sent (e.g., by user 38 selecting “Send Message” button 162 in email creation interface 150), or upon manual request by user 38. Various other arrangements and timing may be utilized for sending 100 the request for dynamic email content.

Sending 100 the request for dynamic email content may include sending 100 a request for the dynamic email content based upon, at least in part, one or more attributes of the email message. As described above, an email message may include a variety of attributes including, but not limited to, one or more intended email recipient, subject matter of the email, language, sender, as well as various other attributes, one or more of which may be application specific.

Continuing with the above stated example in which an email is being sent in response to a customer service request, the dynamic email content requested by dynamic content process 10 and/or email client application 34 may be based upon, at least in part, the subject matter of the email. For example, email creation interface 150 may have been rendered in response to user 38 selecting, via onscreen pointer 158, a specific “problem ticket” in (e.g., “problem ticket” 202) in problem management interface 200. “Problem ticket” 202 may be indicative of the subject matter of the email message. For example, as described above, “problem ticket” 202 may be associated with a particular customer, a particular product family, a specific product within a product family, etc. Dynamic content process 10 may send 100 a request for dynamic email content based upon, at least in part, the subject matter of the email message, as indicted by “problem ticket” 202. Similarly, the subject matter of the email message may be abstracted, for example, from one or more key words within “Subject” field 154, an email message body, or other reference.

Additionally, dynamic content process 10 may request dynamic email content based upon, at least in part, the language of the email, e.g., which may be indicated by the language selected via language field 156 in email creation interface 150. Similarly, dynamic email content may be requested based upon, at least in part, a geographic location of one or more intended recipients of the email message. For example, the geographic location of the intended recipient “customer@ibm.com” may be known, e.g., based upon, at least in part, information included in a contacts or similar directory. Similarly, in the context of a customer service message, a geographic location of the intended recipient may be associated with “problem ticket” 202. As such, the geographic location of the intended recipient may be abstracted from information associated with “problem ticket” 202.

Sending 100 the request for dynamic email content may include sending 108 a web service request to a data store. Continuing with the above-stated example, dynamic content process 10 and/or email client application 34 may allow web services functionality. Sending 100 the request for dynamic email content may include sending 108 a web service request for dynamic email content, e.g., to web services application 58. For example, dynamic email content process 10 and/or email client application 34 may pass the one or more attributes based upon which, at least in part, the dynamic email content may be selected to web services application 58. Web services application 58 may extract dynamic email content based upon the web service request from one or more data stores (e.g., one or more of databases 42, 44). For example, web services application 58 may execute a search query on one or more of databases 42, 44 (e.g., by issuing a search query to one or more of database application 50, 52) based upon, at least in part, the one or more attributes.

The data store may include a centrally managed database accessible by a plurality of email client applications (e.g., one or more of email client applications 34, 36) and/or by one or more dynamic content processes (e.g., one or more of dynamic content processes 10, 12, 14). One or more pieces of dynamic email content may reside in one or more of databases 42, 44. Continuing with the above-stated example in which dynamic content process 10 and/or email client application 34 may send 100 a request for dynamic email content based upon, at least in part, one or more attributes of the email message, the dynamic email content may include a variety of content selections. The variety of content selections may be categorized according to the various possible attributes of the email message.

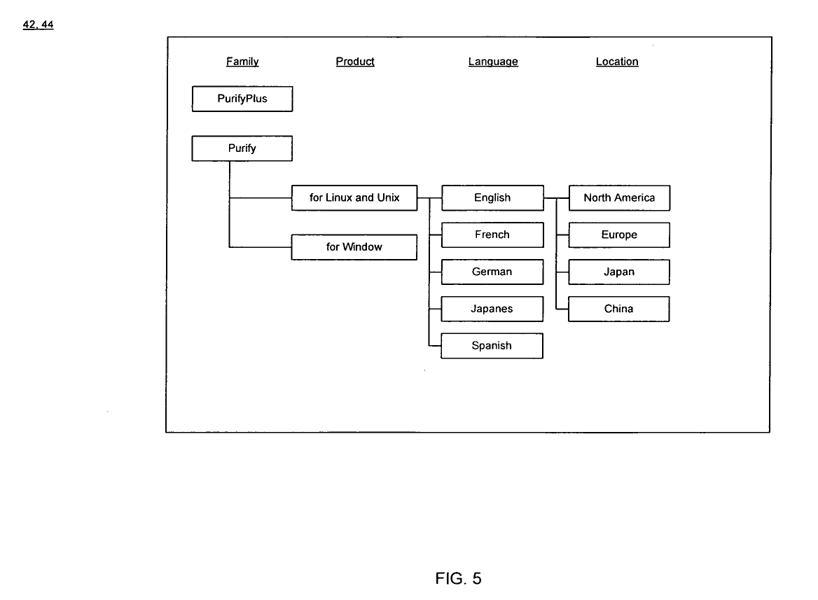

For example, and referring also to FIG. 5, one or more of databases 42, 44 may include one or more content selections for each of a plurality of product families, namely “PurifyPlus™” and “Purify™”. Additionally, the one or more content selections for the product family “Purify™” may include one or more content selections for each product within the family, namely “for Linux and Unix” and “for Windows”. The one or more content selections for the product “for Linux and Unix” may include one or more content selections for each of a plurality of languages, namely “English”, “French”, “German”, “Japanese”, and “Spanish”. Further, the one or more content selections for each language may include one or more content selections for various geographic regions, e.g., “North America”, “Europe”, “Japan”, and “China”. The geographic regions may, of course, exhibit a finer level of granularity. For example, the geographic regions may relate to regions of a country, states, cities, and the like.

As mentioned, databases 42, 44 may include centrally managed databases. The content selections within databases 42, 44 may be updated, modified, added, and deleted by one or more authorized users. For example, user 62 may access one or more of databases 42, 44 using client electronic device 64. According to an implementation, user 62 may utilize client application 60 (e.g., which may be a web browser) to update, modify, add, and delete content selections via a web interface (e.g., which may provide a user-friendly interface to one or more of databases 42, 44) Various additional/alternative mechanisms may be utilized for updating, modifying, adding, and/or deleting the content selections within one or more of databases 42, 44, for example, dedicated database client applications.

Continuing with the above stated example, web services application 58 may execute a query on one or more of databases 42, 44 for dynamic email content based upon, at least in part, one or more attributes associated with “problem ticket” 202. For example, web services application 58 may execute a query on one or more of databases 42, 44 for dynamic email content associated with Purify™ for Solaris (e.g., which may be encompassed by Purify™ for Linux and UNIX), in English, and for the North American geographic region. One or more of databases 42, 44 may return a content selection based upon, at least in part, the one or more attributes utilized by web services application 58 in forming the query.

Dynamic content process 10 and/or email client application 34 may receive 102 the dynamic email content (i.e., the content selection returned in response to the query) from the data store (e.g., one or more of databases 42, 44). Receiving 102 the dynamic email content may include receiving dynamic email content selected based upon, at least in part, one or more attributes of the email message. As discussed, the one or more attributes of the email message may include one or more of a subject matter of the email message, a language of the email message, and a geographic location of one or more intended recipients of the email message.

For example, as mentioned, web services application 58 may execute a query on one or more of databases 42, 44 for dynamic email content based upon, at least in part, one or more attributes of the email messages (e.g., based upon, at least in part, one or more attributes associated with “problem ticket” 202). Accordingly, the dynamic email content selection returned in response to the query may include dynamic email content based upon, at least in part, the one or more attributes of the email message, e.g., which may be, for example, based upon, at least in part, one or more attributes associated with “problem ticket” 202.

Receiving 102 the dynamic email content may include receiving 110 a web service response from the data store including the dynamic email content. Continuing with the above stated example, web services application 58 may pass the dynamic email content retrieved from one or more of databases 42, 44 as a result of the executed query. Dynamic content process 10 and/or email client application 34 may receive 110 the dynamic email content passed from web services application 58.

Dynamic content process 10 may populate 104 at least a portion of the email message with the dynamic email content received 102 from one or more of databases 42, 44. For example, an email message template may include a text box. The received 102 dynamic email content may be inserted into the text box in the email message template, with the email client knowing where in the body of the email to place the contents of this textbox. Additionally/alternatively, dynamic content process 10 may populate 104 at least a portion of email message with the received 102 dynamic email content by inserting the received 102 dynamic email content into a pre-selected and/or user selected region of the email.

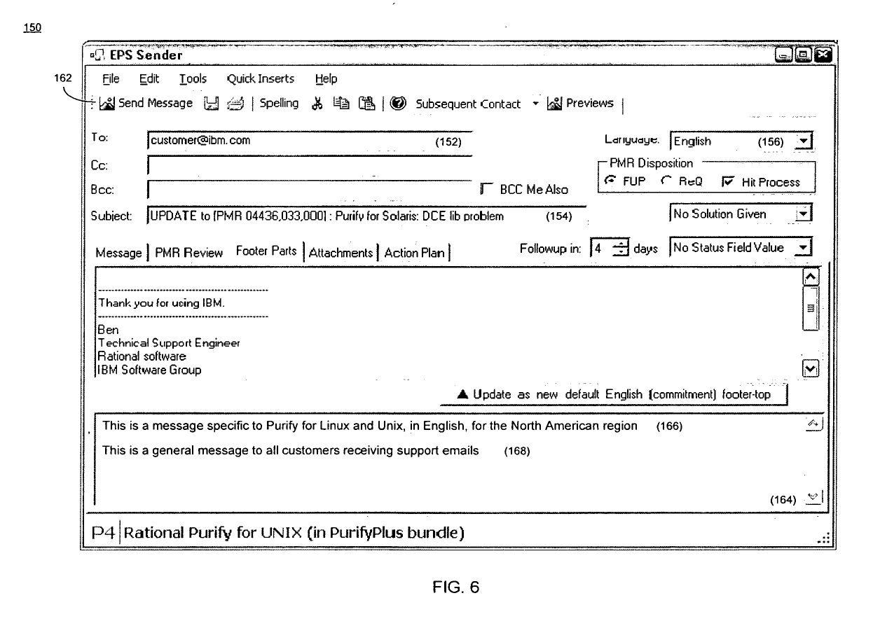

Populating 104 at least a portion of the email message may include providing 112 at least one email footer including the received 102 dynamic email content. Continuing with the above-stated example, and referring also to FIG. 6 email creation interface 150 may include footer preview pane 164. Dynamic content process 10 and/or email client application 34 may display the received 102 dynamic email content in footer preview pane 164. As shown, dynamic content process 10 and/or email client application 34 may provide 112 first footer portion 166 including received 102 dynamic email content that is based upon attributes of the email message (e.g., the dynamic email content is specific to Purify™ for Linux and UNIX, the North American region, and is in English). Additionally/alternatively, dynamic content process 10 and/or email client application 34 may provide 112 second footer portion 168 including received 102 dynamic email content that may include a general message to all customers receiving a customer support email. The dynamic email content of first footer portion 166 and second footer portion 168 may be included as footers of the email message when the email message is sent (e.g., by selecting “Send Message” button 162) to the intended recipient.

A number of implementations have been described. Nevertheless, it will be understood that various modifications may be made. Accordingly, other implementations are within the scope of the following claims.

What is claimed is:

1. A method comprising:
sending a request for a dynamic email content;
receiving the dynamic email content from a data store; and
populating at least a portion of an email message with the received dynamic email content.

2. The method of claim 1, wherein sending the request for dynamic email content includes sending a request for the dynamic email content based upon, at least in part, one or more attributes of the email message.

3. The method of claim 2, wherein the one or more attributes of the email message include one or more of a subject matter of the email message; a language of the email message; and a geographic location of one or more intended recipients of the email message.

4. The method of claim 1, wherein sending the request for dynamic email content includes sending a web service request to the data store.

5. The method of claim 1, wherein receiving the dynamic email content includes receiving a web service response from the data store including the dynamic email content.

6. The method of claim 1, wherein receiving the dynamic email content includes receiving dynamic email content selected based upon, at least in part, one or more attributes of the email message.

7. The method of claim 6, wherein the one or more attributes of the email message include one or more of a subject matter of the email message, a language of the email message, and a geographic location of one or more intended recipients of the email message.

8. The method of claim 1, wherein the data store includes a centrally managed database accessible by a plurality of email clients.

9. The method of claim 1, wherein populating at least a portion of the email message includes providing at least one email footer including the received dynamic email content.

10. The method of claim 1, further including receiving by an email client an indicator of one or more of a subject matter of the email message, a language of the email message, and a geographic location of at least one intended recipient of the email message.

11. A computer program product residing on a computer readable storage medium having a plurality of instructions stored thereon, which, when executed by a processor, cause the processor to perform operations comprising:
sending a request for a dynamic email content;
receiving the dynamic email content from a data store; and
populating at least a portion of an email message with the received dynamic email content.

12. The computer program product of claim 11, wherein the instructions for sending the request for dynamic email content include instructions for sending a request for the dynamic email content based upon, at least in part, one or more attributes of the email message.

13. The computer program product of claim 12, wherein the one or more attributes of the email message include one or more of a subject matter of the email message; a language of the email message; and a geographic location of one or more intended recipients of the email message.

14. The computer program product of claim 11, wherein the instructions for sending the request for dynamic email content include instructions for sending a web service request to the data store.

15. The computer program product of claim 11, wherein the instructions for receiving the dynamic email content include instructions for receiving a web service response from the data store including the dynamic email content.

16. The computer program product of claim 11, wherein the instructions for receiving the dynamic email content include instructions for receiving dynamic email content selected based upon, at least in part, one or more attributes of the email message.

17. The computer program product of claim 16, wherein the one or more attributes of the email message include one or more of a subject matter of the email message, a language of the email message, and a geographic location of one or more intended recipients of the email message.

18. The computer program product of claim 11, wherein the data store includes a centrally managed database accessible by a plurality of email clients.

19. The computer program product of claim 11, wherein the instructions for populating at least a portion of the email message include instructions for providing at least one email footer including the received dynamic email content.

20. The computer program product of claim 11, further including instructions for receiving by an email client an indicator of one or more of a subject matter of the email message, a language of the email message, and a geographic location of at least one intended recipient of the email message.
